(19) United States
(12) Patent Application Publication
(10) Pub. No.: US 2017/0030558 A1
(43) Pub. Date: Feb. 2, 2017

(54) LIGHTING DEVICE

(71) Applicant: PANASONIC INTELLECTUAL PROPERTY MANAGEMENT CO., LTD., Osaka (JP)

(72) Inventors: Motohiro SAIMI, Hyogo (JP); Shinichi ANAMI, Osaka (JP); Hideharu KAWACHI, Hyogo (JP)

(21) Appl. No.: 15/218,627

(22) Filed: Jul. 25, 2016

(30) Foreign Application Priority Data
Jul. 28, 2015 (JP) 2015-149055

(51) Int. Cl. F21V 14/04; F21V 1/10; F21K 9/64; F21V 8/00; F21V 7/00

(52) U.S. Cl. CPC F21V 14/04; G02B 6/0008; F21V 7/0066; F21K 9/64; F21V 1/10; F21W 2131/405

(57) ABSTRACT

A lighting device which uses laser light as excitation light, the lighting device including: a mirror which has a reflective surface and reflects the laser light; a light emitter which emits light having a wavelength different from a wavelength of the laser light, when illuminated by the laser light, the light emitter being located to receive the laser light reflected by the mirror; a first pivot which causes the light emitter to pivot about a first pivotal axis, the reflective surface of the mirror lying on the first pivotal axis; and a conjunction means which causes the mirror to pivot about the first pivotal axis in conjunction with the light emitter pivoting, a pivotal angle of the mirror being half of a pivotal angle of the light emitter.

### CROSS REFERENCE TO RELATED APPLICATION

This application claims the benefit of priority of Japanese Patent Application Number 2015-149055, filed Jul. 28, 2015, the entire content of which is hereby incorporated by reference.

### BACKGROUND

1. Technical Field

The present disclosure relates to a lighting device which uses laser light as excitation light.

2. Description of the Related Art

Conventionally, there is a lighting device which uses laser light transmitted from an optical fiber as excitation light to cause phosphor to emit light and converts a color of the light into a desired color for illumination. Japanese Unexamined Patent Application Publication No. 2015-65142 (Patent Literature 1) discloses a technology related to such a lighting device.

### SUMMARY

It is necessary to bend an optical fiber to change an illumination direction of the lighting device disclosed in Patent Literature 1. If the illumination direction is changed a great number of times, the optical fiber can be damaged. Moreover, a range in which the illumination direction is changeable is limited due to a limited bend radius of the optical fiber.

Thus, an object of the present disclosure is to provide a lighting device which uses laser light as excitation light and whose illumination direction is flexibly changeable, without bending an optical fiber transmitting the laser light.

A lighting device according to one aspect of the present disclosure is a lighting device which uses laser light as excitation light, the lighting device including: a mirror which has a reflective surface and reflects the laser light; a light emitter which emits light having a wavelength different from a wavelength of the laser light, when illuminated by the laser light, the light emitter being located to receive the laser light reflected by the mirror; a first pivot which causes the light emitter to pivot about a first pivotal axis, the reflective surface of the mirror lying on the first pivotal axis; and a conjunction means which causes the mirror to pivot about the first pivotal axis in conjunction with the light emitter pivoting, a pivotal angle of the mirror being half of a pivotal angle of the light emitter.

According to the lighting device of one aspect of the present disclosure, an illumination direction of the lighting device which uses laser light as excitation light is changeable, without bending an optical fiber transmitting the laser light.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a perspective view of a lighting device according to an embodiment from the underside;

FIG. 2 is a cut-away perspective view of the lighting device according to the embodiment to reveal an inside view from the underside;

FIG. 3 is a cut-away plan view of the lighting device according to the embodiment, with a portion removed to laterally show a vicinity of a mirror, a vicinity of a light emitter, and a vicinity of a second pivot;

FIG. 4 is a plan view laterally showing a vicinity of a first pivot of the lighting device according to the embodiment;

FIG. 5 is a perspective view illustrating use of the lighting device according to the embodiment; and

FIG. 6 is a cut-away plan view of a lighting device according to another embodiment, with a portion removed to laterally show a vicinity of a mirror, a vicinity of a light emitter, and a vicinity of a semiconductor laser element.

### DETAILED DESCRIPTION OF EMBODIMENTS

Hereinafter, a lighting device according to embodiments of the present disclosure is described, with reference to the accompanying drawings. The embodiments described below are each merely one specific example of the present disclosure. Thus, values, shapes, materials, components, and arrangement and connection between the components shown in the following embodiments are merely by way of illustration and not intended to limit the present disclosure. Therefore, among the components of the embodiments below, components not recited in any one of the independent claims defining the most generic part of the inventive concept of the present disclosure are described as arbitrary components.

The figures are schematic illustration and do not necessarily illustrate the present disclosure precisely. In the figures, the same reference sign is used to refer to the same component.

### EMBODIMENT

In the following, an embodiment is described.

[Configuration of Lighting Device]

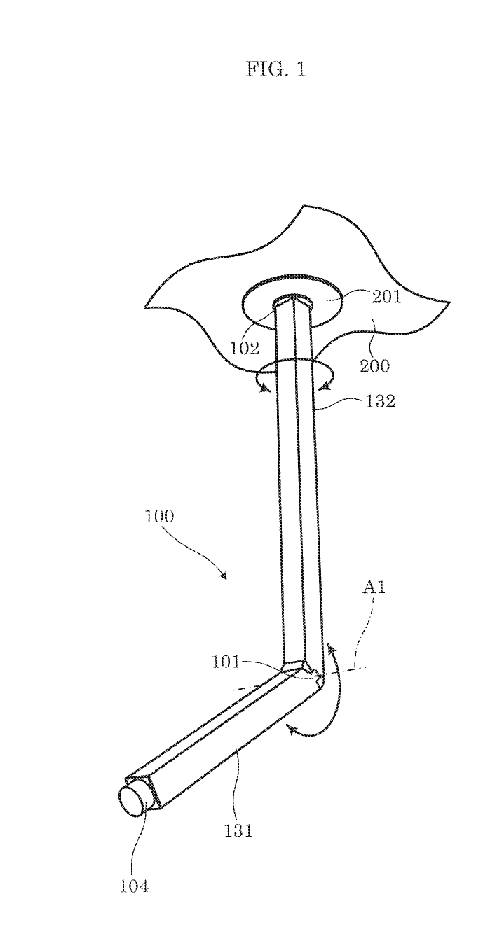

FIG. 1 is a perspective view of a lighting device from the underside.

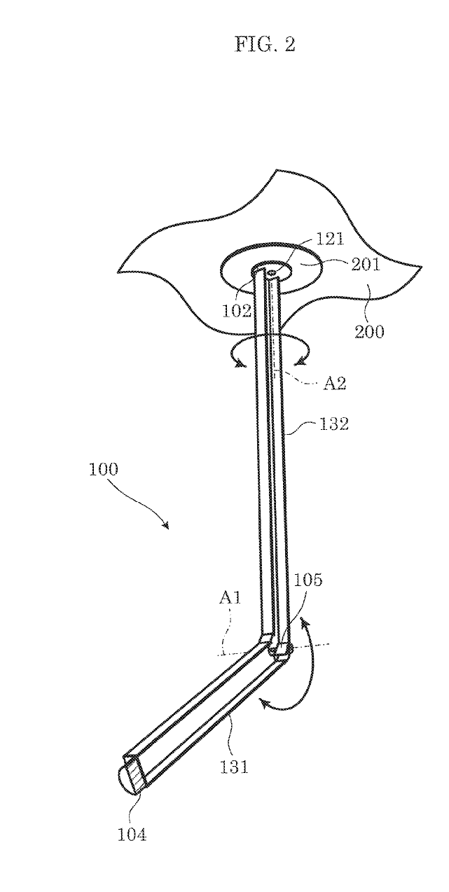

FIG. 2 is a cut-away perspective view of the lighting device to reveal an inside view from the underside.

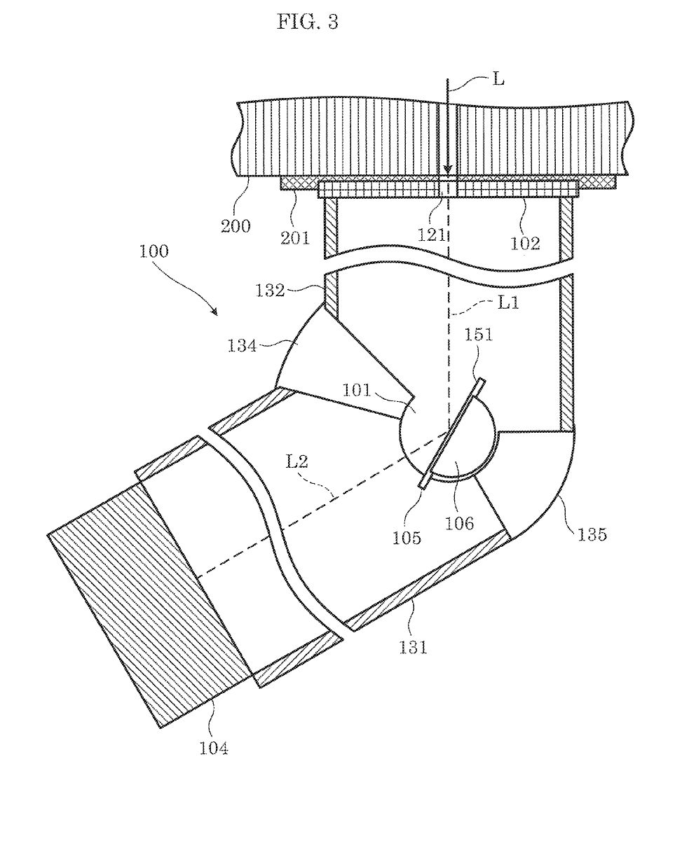

FIG. 3 is a cut-away plan view of the lighting device, with a portion removed to laterally show a vicinity of a mirror, a vicinity of a light emitter, and a vicinity of a second pivot.

As shown in the figures, lighting device 100 emits white light, using laser light L as excitation light source. Lighting device 100 includes first pivot 101, second pivot 102, light emitter 104, first conduit 131, second conduit 132, mirror 105 (see FIGS. 2 and 3), and conjunction means 106 (see FIG. 3). In the present embodiment, lighting device 100 is configured to be mounted on mounting part 201 installed in construction 200 such as the ceiling or a floor.

First pivot 101 is a feature which causes light emitter 104 to pivot about first pivotal axis A1 in a vertical plane. First pivotal axis A1 virtually extends along the horizontal direction. In the present embodiment, first pivot 101 is a hinge which flexibly couples first conduit 131 and second conduit 132. First pivot 101 causes first conduit 131 to pivot about first pivotal axis A1 in the vertical plane, relative to second conduit 132 that is secured to construction 200, thereby causing light emitter 104 mounted on the tip of first conduit 131 to pivot about first pivotal axis A1.

Second pivot 102 is a feature which causes light emitter 104 and mirror 105 to pivot about second pivotal axis A2 (see FIG. 2) extending in the vertical direction. In the present embodiment, second pivot 102 is a pivoting mechanism disposed between mounting part 201 and second conduit 132. Second pivot 102 causes second conduit 132 to pivot about second pivotal axis A2 relative to mounting part 201, thereby causing first conduit 131, which is connected to the tip of second conduit 132, and light emitter 104, which is mounted on the tip of first conduit 131, to pivot along a horizontal plane. Second pivot 102 also causes mirror 105 that is mounted on second conduit 132 to pivot about second pivotal axis A2. It should be noted that second pivotal axis A2 coincides with optical axis L1 (see FIG. 3) of laser light which is incident on mirror 105. The positional relationship between mirror 105 and optical axis L1 of the laser light is maintained even if mirror 105 rotates about second pivotal axis A2.

As described above, light emitter 104 is caused to pivot in the vertical plane by first pivot 101, and caused to pivot in the horizontal plane by second pivot 102. Thus, lighting device 100 can cause light emitter 104 to pivot so that light emitter 104 points in an arbitrary direction within a hemispheric range.

Mirror 105 reflects incident laser light (shown in terms of optical axis L1 in FIG. 3) toward light emitter 104. In the present embodiment, a rectangular planar mirror is employed for mirror 105. It should be noted that the shape and material of mirror 105 are not particularly limited, and those corresponding to a wavelength of the laser light, which is used as excitation light, may be selected.

Mirror 105 has reflective surface 151 lying on first pivotal axis A1 in the vicinity of first pivotal axis A1 (see FIG. 2). In the present embodiment, reflective surface 151 of mirror 105 contains first pivotal axis A1. Mirror 105 is mounted on second conduit 132 in a manner that reflective surface 151 pivots about first pivotal axis A1. It should be noted that reflective surface 151 in the vicinity of first pivotal axis A1 as used herein refers to reflective surface 151 close to first pivotal axis A1 to an extent that allows the laser light (shown in terms of optical axis L2 in FIG. 3) reflected by mirror 105 to reach light emitter 104 even when mirror 105 pivots, and includes a state in which reflective surface 151 contains first pivotal axis A1. Further, mirror 105 is mounted at a position where optical axis L1 on the light-incident side and first pivotal axis A1 intersects in reflective surface 151 and a point of the intersection is in the center of reflective surface 151.

Conjunction means 106 shown in FIG. 3 is a feature which causes mirror 105 to pivot about first pivotal axis A1, in conjunction with the pivotal movement of first conduit 131 relative to second conduit 132, namely, the pivotal movement of light emitter 104 about first pivotal axis A1. If an operator or the like causes light emitter 104 to pivot about first pivotal axis A1 in the vertical plane, in conjunction with which conjunction means 106 causes mirror 105 to pivot in the same direction as light emitter 104 pivots. Mirror 105 pivots in conjunction with the pivotal movement of light emitter 104 about first pivotal axis A1, at a pivotal angle that is half of a pivotal angle at which light emitter 104 pivots about optical axis L1 of the incident laser light.

It should be noted that conjunction means 106 is implemented by a gear mechanism, for example. Although not shown, conjunction means 106 includes a first gear which pivots about first pivotal axis A1, together with first conduit 131. Conjunction means 106 also includes a second gear which pivots about first pivotal axis A1, together with mirror 105. Furthermore, conjunction means 106 includes a coupling gear group which couples the first gear and the second gear in a manner that the second gear pivots at an angle half of an angle at which the first gear pivots. In this manner, conjunction means 106 makes use of the gear mechanism to convey half the pivotal angle of light emitter 104 to mirror 105.

First conduit 131 is a conduit member which covers the optical path (optical axis L2) of the laser light reflected by mirror 105. The laser light is transmitted through the interior cavity (in air) of first conduit 131. In the present embodiment, first conduit 131 is a squared conduit and has an inner peripheral surface that has a member or structure which absorbs the laser light.

Second conduit 132 is a conduit member which covers the optical path (optical axis L1) of the laser light which is incident on mirror 105. The laser light is transmitted through the interior cavity (in air) of second conduit 132. In the present embodiment, as with first conduit 131, second conduit 132 is a squared conduit and has an inner peripheral surface that has a member or structure which absorbs the laser light.

The members which absorb the laser light as used herein refer to members that have dyes which absorb blue, if the laser light is blue, for example. The structures which absorb the laser light as used herein refers to structures in which the inner peripheral surface has fine roughness, thereby diffusely reflecting and extinguishing the laser light.

While the materials and methods of fabricating first conduit 131 and second conduit 132 are not particularly limited, examples of which include forming a metal sheet by bending work. In the present embodiment, first conduit 131 and second conduit 132 also serve as structural members of lighting device 100. First conduit 131 and second conduit 132 cause light emitter 104 to pivot about first pivotal axis A1 and second pivotal axis A2, respectively. Moreover, first conduit 131 and second conduit 132 have structural strengths to maintain light emitter 104 to a predetermined position.

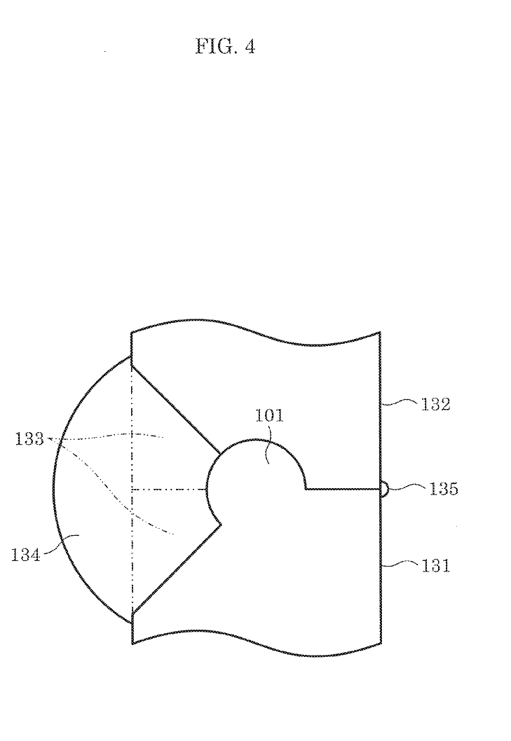

As shown in FIG. 4, in order to prevent cross interference between first conduit 131 and second conduit 132 when first conduit 131 is caused to pivot in the direction toward second conduit 132 by first pivot 101, first conduit 131 and second conduit 132 each have notch 133. In the present embodiment, first conduit 131 is configured to pivot to a horizontal position from a state in which first conduit 131 is on the vertical line along second conduit 132. Notches 133 are formed by cutting first conduit 131 and second conduit 132 at angles that can permit the pivotal movement of first conduit 131. While the angles of notches 133 are evenly distributed to first conduit 131 and second conduit 132 in FIG. 4, the present disclosure is not limited thereto. The angular distribution may be selected arbitrary. Only one of first conduit 131 and second conduit 132 may have notch 133.

In the present embodiment, first shield member 134 disposed covering notches 133 is provided between first conduit 131 and second conduit 132. First shield member 134 prevents the laser light passing through first conduit 131 and second conduit 132 from undesirably leaking out from between notches 133. First shield member 134, although not shown in detail, changes its form according to the pivotal movement of first conduit 131 relative to second conduit 132. Examples of such a structure which can shield the laser light while changing its form include a bellows (hood-shaped) structure and a shutter structure.

As shown in FIGS. 3 and 4, as first conduit 131 is caused to pivot in the direction toward second conduit 132 by first pivot 101, a gap is created between first conduit 131 and second conduit 132 on a side opposite the side where notches 133 are formed. In the present embodiment, second shield member 135 is provided between first conduit 131 and second conduit 132 to cover the gap. Second shield member 135 has the same or similar structure to first shield member 134 in which its form changes following the pivotal movement of first conduit 131 relative to second conduit 132. Thus, the laser light passing through first conduit 131 is prevented from undesirably leaking out through the gap, no matter how angulated the first conduit 131 is.

Light emitter 104 is a device which emits light when illuminated by the laser light reflected by mirror 105. The light emitted by light emitter 104 has a wavelength different from a wavelength of the laser light.

Light emitter 104 includes phosphor particles in a dispersed form, which are excited by the laser light and emit phosphor light, for example. The phosphor particles emit the phosphor light when illuminated by the laser light. Specifically, light emitter 104 is made of transparent resin or a glass and in which phosphor particles are dispersed or in which phosphor particles are hardened. In other words, it can be said that light emitter 104 is a wavelength converting material which converts the laser light into phosphor light.

In the present embodiment, light emitter 104 emits white light, and includes three types of phosphor in a proper ratio: first phosphor; second phosphor; and third phosphor. When illuminated by the laser light, the first phosphor emits red light, the second phosphor emits blue light, and the third phosphor emits green light.

While the type and characteristics of the phosphors are not particularly limited, desirably, the phosphors are highly thermo tolerant since the laser light used as the excitation light has relatively high output.

Preferably, the light emitter in which the phosphor are held in a dispersed form is, but not particularly limited to, highly transparent because it increases the radiation efficiency of white light, and, preferably, highly heat resistant because relatively high output laser light is incident onto the light emitter.

While light emitter 104 is described in the present embodiment with reference to transmissive light emitter 104 which emits light from a surface opposite a surface to which the laser light is emitted, it should be noted that light emitter 104 may be a reflective light emitter which emits light from the surface to which the laser light is emitted.

Alternatively, light emitter 104 may include an optic which changes the diameter of the beam of the laser light, and may also include scattering-particles for scattering the light or a functional membrane for efficiently transmitting the laser light to the phosphor, for example.

[Use of Lighting Device]

Next, use of lighting device 100 configured as set forth above is specifically described.

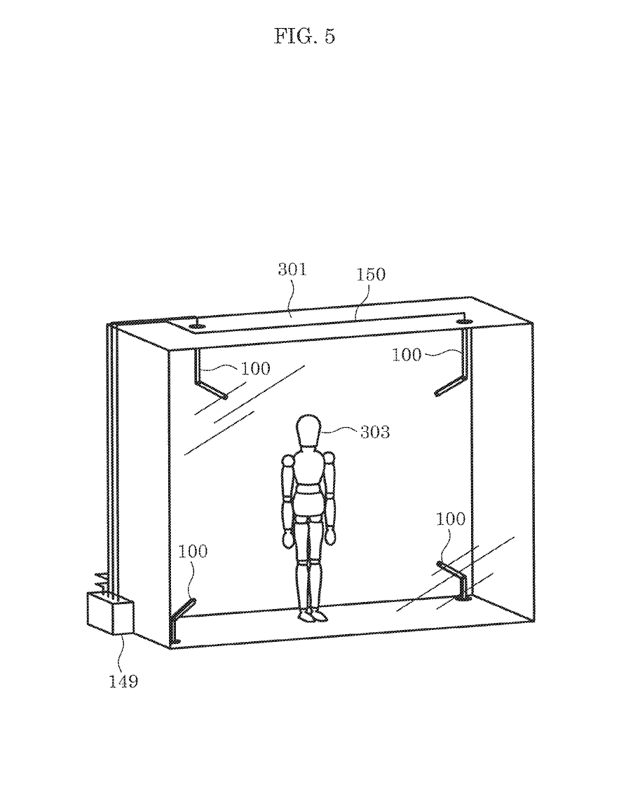

FIG. 5 is a perspective view illustrating an example of use of the lighting device.

As shown in the figure, in the present embodiment, a plurality of lighting devices 100 are mounted on the ceiling and several points on the floor of show window 301 which is one of constructions. Lighting devices 100 serve as spot lights which illuminate mannequin 303. Light source device 149 is provided external to show window 301. The laser light is emitted from light source device 149 and transmitted to each lighting devices 100 through optical fibers 150 routed external to show window 301.

Light source device 149 generates the laser light, and supplies the laser light to the plurality of lighting devices 100 using optical fibers 150. As a specific example, light source device 149 includes a plurality of semiconductor laser elements which emit laser light beams having wavelengths in a range of violet to blue (430 nm to 490 nm). Disposing the semiconductor laser elements in one place as such allows coolers which cool the semiconductor laser elements to be disposed collectively, thereby increasing the cooling efficiency and allowing waste heat or the like to be utilized to heat water, for example.

As shown in FIG. 3, the laser light emitted from light source device 149 is transmitted via optical fiber 150, and laser light L exited from the tip of optical fiber 150 is introduced into lighting device 100. Specifically, as shown in FIG. 2, second pivot 102 has through hole 121 surrounding second pivotal axis A2, and laser light L exited from optical fiber 150 passes through through hole 121 and is introduced into second conduit 132 of lighting device 100.

Then, laser light L introduced into second conduit 132 passes through an air inside second conduit 132, and is reflected by mirror 105 and introduced into first conduit 131. Then, laser light L passes through an air inside first conduit 131 and is emitted to light emitter 104.

In light emitter 104, when illuminated by the laser light as the excitation light, the different types of phosphor emit phosphor light beams having different waveforms, and light that can be seen white as a whole is emitted external to lighting device 100.

Here, the direction of the light emitted from lighting device 100 changes if the operator causes light emitter 104 of lighting device 100 to pivot about second pivotal axis A2. In this case, since optical axis L1 (see FIG. 3) of the laser light incident on mirror 105 and second pivotal axis A2 coincide with each other, the positional relationship between the laser light and mirror 105 in the vertical plane is maintained in the same state. Thus, even if lighting device 100 is caused to pivot about second pivotal axis A2, the laser light reflected by mirror 105 is always directed to light emitter 104, thereby allowing lighting device 100 to emit white light.

If the operator causes light emitter 104 to pivot about first pivotal axis A1 together with first conduit 131 to change an angle of elevation or the dip of the light emitted by lighting device 100, in conjunction with the pivotal movement of light emitter 104 owing to conjunction means 106 mirror 105 is caused to pivot at an angle half of the angle at which light emitter 104 pivots in the same direction as light emitter 104 pivots. Thus, the laser light reflected by mirror 105 is always directed to light emitter 104, thereby allowing lighting device 100 to emit white light. Since optical axis L1 of the laser light, which is incident on mirror 105, and first pivotal axis A1 (see FIG. 2), which is the pivotal axis of mirror 105, are intersecting at right angles, the laser light is always directed to light emitter 104 even if light emitter 104 is caused to pivot flexibly.

[Effects]

According to lighting device 100 as described above, despite that lighting device 100 is a lighting device which uses laser light as excitation light source, a direction of light emitted by lighting device 100 is changeable, without bending an optical fiber transmitting the laser light. Consequently, lighting device 100 is so free of problems that the optical fiber is not damaged no matter how many times the direction of the light emitted by lighting device 100 is changed. Thus, a spot light, universal downlight, etc. that are durable and long life can be provided.

Moreover, since lighting device 100 does not require the optical fiber to be bent to change the direction of light, the direction of the light emitted by lighting device 100 is changeable freely, without being restricted by the limit of bending of the optical fiber.

Moreover, since first conduit 131 and mirror 105 are caused to pivot in conjunction using the gear mechanism, stable conjunction operation is achieved.

Further, since the optical paths through which the laser light is transmitted in an air are covered with first conduit 131, second conduit 132, first shield member 134, and second shield member 135, the laser light is prevented from undesirably leaking out of lighting device 100. Thus, lighting device 100 is safe.

Furthermore, lighting device 100 according to the present embodiment does not include a light source and makes use of the laser light transmitted from light source device 149 external to lighting device 100. Thus, lighting device 100 need not be equipped with a cooler for cooling the semiconductor laser elements and the like, nor need not be supplied with power. This allows lighting device 100 to be small and lightweight, achieving an inexpensive lighting device.

### Other Embodiments

While lighting device 100 according to the present disclosure has been described with reference to the above embodiment, the present disclosure is not limited to the above embodiment.

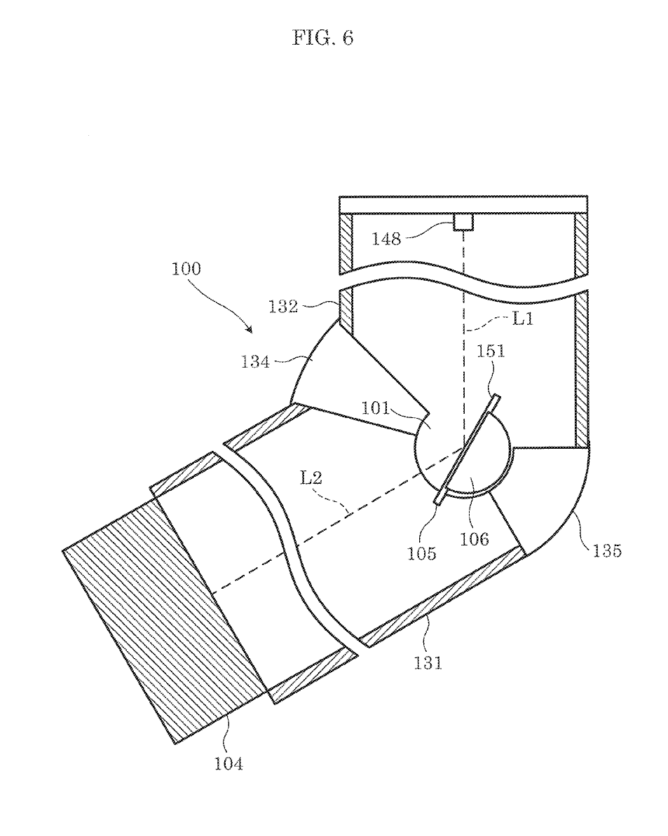

While, in the above embodiment, light source device 149 which includes the semiconductor laser elements is provided external to lighting device 100 and the laser light is transmitted by optical fiber 150 and introduced into lighting device 100, the present disclosure is not limited to this aspect. For example, as shown in FIG. 6, lighting device 100 may include, at the tip of second conduit 132, semiconductor laser element 148 which emits laser light having optical axis L1.

While in the above embodiment, conjunction means 106 which causes first pivot 101 and mirror 105 to pivot in conjunction has been described with reference to the gear mechanism, the present disclosure is not limited thereto. For example, conjunction means 106 may be a belt drive or the like, or may be electrically-powered conjunction means 106 which is a combination of an encoder and a servomotor.

Alternatively, light emitter 104 may include various optics such as one that expands the diameter of the beam of the laser light. For example, light emitter 104 may include, as an optic, a reflective film or the like for efficiently emitting the incident laser light to the phosphor, or may include, as an optic, a light-transmissive cover or the like which diffuses and releases the light emitted by light emitter 104.

While first conduit 131 and second conduit 132 have been described as being squared conduits in the above embodiment, the shapes of first conduit 131 and second conduit 132 are not particularly limited insofar as they are conduit. A cylindrical shape or any other shape may be employed.

It should be noted that the above embodiment can be represented as follows: lighting device 100 which uses laser light as excitation light, lighting device 100 including: first conduit 131 having a first end at which light emitter 104 is disposed and a second end; second conduit 132 having a first end on which the laser light is incident and a second end; a pivotal connector connected to the second end of first conduit 131 and the second end of second conduit 132, and pivotally connecting first conduit 131 and second conduit 132; and mirror 105 disposed in the pivotal connector, wherein: mirror 105 has reflective surface 151 and reflects the laser light coming through first conduit 131 toward second conduit 132; light emitter 104 emits light having a wavelength different from a wavelength of the laser light, the pivotal connector causes first conduit 131 to pivot about first pivotal axis A1, and causes mirror 105 to pivot about first pivotal axis A1 in conjunction with first conduit 131 pivoting, and mirror 105 is disposed such that reflective surface 151 of mirror 105 lies on first pivotal axis A1, and a pivotal angle of mirror 105 is half of a pivotal angle of light emitter 104.

In other instances, various modifications to the embodiments according to the present disclosure described above that may be conceived by a person skilled in the art and embodiments implemented by any combination of the components and functions shown in the above embodiments are also included within the scope of the present disclosure, without departing from the spirit of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A lighting device which uses laser light as excitation light, the lighting device comprising:
a mirror which has a reflective surface and reflects the laser light;
a light emitter which emits light having a wavelength different from a wavelength of the laser light, when illuminated by the laser light, the light emitter being located to receive the laser light reflected by the mirror;
a first pivot which causes the light emitter to pivot about a first pivotal axis, the reflective surface of the mirror lying on the first pivotal axis; and
a conjunction means which causes the mirror to pivot about the first pivotal axis in conjunction with the light emitter pivoting, a pivotal angle of the mirror being half of a pivotal angle of the light emitter.

2. The lighting device according to claim 1, wherein
the conjunction means includes a gear mechanism, and
a gear ratio of the gear mechanism is set to cause the mirror to pivot at half the pivotal angle of the light emitter.

3. The lighting device according to claim 1, further comprising
a second pivot which causes the light emitter and the mirror to pivot about a second pivotal axis that coincides with an optical axis of the laser light which is incident on the mirror.

4. The lighting device according to claim 1, further comprising
a first conduit which covers an optical path of the laser light reflected by the light reflector.

5. The lighting device according to claim 4, wherein the light emitter is attached to an end of the first conduit.

6. The lighting device according to claim 4, wherein
an inner surface of the first conduit absorbs the laser light.

7. The lighting device according to claim 4, further comprising
a second conduit which covers an optical path of the laser light incident on the mirror, wherein
at least one of the first conduit and the second conduit includes a notch for preventing cross interference between the first conduit and the second conduit.

8. The lighting device according to claim 1, further comprising a light source for emitting the laser light.

9. A lighting device which uses laser light as excitation light, the lighting device comprising:
a first conduit having a first end at which a light emitter is disposed and a second end;
a second conduit having a first end on which the laser light is incident and a second end;
a pivotal connector connected to the second end of the first conduit and the second end of the second conduit, and pivotally connecting the first conduit and the second conduit; and
a mirror disposed in the pivotal connector, wherein:
the mirror has a reflective surface and reflects the laser light coming through the first conduit toward the second conduit;
the light emitter which emits light having a wavelength different from a wavelength of the laser light,
the pivotal connector causes the first conduit to pivot about a first pivotal axis, and causes the mirror to pivot about the first pivotal axis in conjunction with the first conduit pivoting, and
the mirror is disposed such that the reflective surface of the mirror lies on the first pivotal axis, and a pivotal angle of the mirror is half of a pivotal angle of the light emitter.
